(19) United States
(12) Patent Application Publication
(10) Pub. No.: US 2021/0402236 A1
(43) Pub. Date: Dec. 30, 2021

(54) Fire Suppression Apparatus, System, and Method

(71) Applicant: Martin George Bruce, Arlington, TX (US)

(72) Inventor: Martin George Bruce, Arlington, TX (US)

(21) Appl. No.: 17/472,661

(22) Filed: Sep. 12, 2021

Related U.S. Application Data
(63) Continuation-in-part of application No. 17/091,717, filed on Nov. 6, 2020.
(60) Provisional application No. 62/931,901, filed on Nov. 7, 2019.

(51) Int. Cl. A62C 35/10; A62C 37/50

(52) U.S. Cl. CPC A62C 35/10; A62C 13/62; A62C 37/50

(57) ABSTRACT

A fire suppression system has a fire suppression apparatus configured to be installed in a target object targeted for fire protection. The apparatus has a storage space containing fire suppression agent. A remote device is configured to wirelessly communicate with the apparatus. A first sensor is configured to measure the storage space pressure and to send a wireless signal to the remote device representing the measured pressure. Another feature of the target object is configured to wirelessly communicate with the remote device and the other feature is not targeted for fire protection. The other feature includes a second sensor configured to measure a characteristic of the other feature and to send a wireless signal to the remote device representing the measured characteristic. The fire suppression apparatus may resemble a traditional fire extinguisher or may have a storage vessel with an outer wall containing the suppression agent. The outer wall may be configured to rupture when exposed to a fire to discharge the agent.

### RELATED APPLICATION DATA

This patent is entitled to the benefit of, as a continuation-in-part of, and claims priority to co-pending U.S. application Ser. No. 17/091,717 filed Nov. 6, 2020 and entitled “Fire Suppression Apparatus, System, and Method”, which claims priority to and the benefit of U.S. Provisional Application Ser. No. 62/931,901 filed Nov. 7, 2019 and entitled “Valve Connect/Disconnect System for Fire Extinguisher/Suppression System.” The entire contents of these prior filed applications are hereby incorporated herein by reference.

### BACKGROUND

### 1. Field of the Disclosure

The present disclosure is generally directed to fire suppression, and more particularly to a fire suppression apparatus, system, and method that may be utilized in multiple different arrangements and for multiple different uses.

### 2. Description of Related Art

Fire suppression systems are known in the art. Such systems are typically installed and used within a wide variety of environments. Just some of many possible examples include buildings; kitchens; control rooms; computer rooms; manufacturing plant machines; CNC machines; wind turbines; paper plants; transportation, such as cars, buses, airplanes, helicopters, campers, recreational vehicles, terminals, and the like; ground equipment; mining; hospitals; document rooms; military equipment and facilities; and the like. These known fire suppression systems all have a common feature in that they are permanently installed and joined together as one unit. These known systems are fixed in place unless activated and discarded or decommissioned and no longer required. These existing fire suppression systems are connected to a source or a container holding a fire suppression agent, such as water. Such permanent installed systems are controlled by manual activation or by automatic activation to release the agent in order to suppress a fire

It is also well known to provide and use standalone manually operated fire extinguishers to suppress fires. Such fire extinguishers or units may be wall mounted, free standing, or housed within an enclosure. The fire extinguishers or units are operated manually by a user to release a fire suppressing agent from the unit and to direct the agent toward a fire to suppress the fire. Fire extinguishing units contain a fire suppressing agent within a container of the unit. The agent may be water, solid or liquid chemicals, a gas, or a mixture of one or more agent types.

One problem with these types of suppression systems or fire extinguisher units is that they are limited to a single type of use. The typical installed suppression system is connected to a store of suppression agent and permanently installed and fixed in place. One problem with such a system is that it is configured to release the agent only from fixed points along the system and thus may not be directed specifically at a source of a fire or the fire itself. Also, the typical fire extinguisher unit is only for manual use. The two types of systems or suppression methods are redundant to one or other. One problem with stand-alone fire extinguishers is that they are not reactive or automatic, but instead only manually operated by a user upon detecting a fire. These problems can cause various restrictions when fighting fires and in choosing the correct equipment to do so.

### SUMMARY

In one example, according to the teachings of the present disclosure, a fire suppression apparatus includes a first storage vessel having an outer wall extending between a first end and a second end of the first storage vessel and defining a storage space within the outer wall between the first and second ends. A stored amount of a fire suppression agent is contained under pressure within the storage space. At least a portion of the outer wall is formed of a material that is configured to rupture when exposed to extreme heat or flame or fire and to discharge the fire suppression agent from the storage space at a location of rupture.

In one example, the material of the portion of the outer wall can be either flammable or non-flammable.

In one example, the fire suppression apparatus can include a pressure sensor configured to measure a pressure within the storage space and to send a wireless signal to a remote device representing a measured pressure within the storage space.

In one example, the remote device can be a handheld device such as a smartphone, laptop computer, or tablet.

In one example, the first storage vessel can include a first tube portion and a second tube portion. A proximal end of the first tube portion can be connected to a proximal end of the second tube portion. The first and second tube portions can combine to define the first storage space.

In one example, the first tube portion can have a larger diameter in cross section than the second tube portion. At least the second tube portion can be flexible allowing the outer wall of the second tube portion to be bent or deformed.

In one example, a fire suppression system can include a plurality of fire suppression apparatuses configured to be installed within a target object.

In one example, each of the plurality of the fire suppression apparatuses can include a corresponding storage space and a pressure sensor configured to measure a pressure within the corresponding storage space and to send a wireless signal to a common remote device representing a measured pressure within the corresponding storage space. Alternatively, two or more of the fire suppression apparatuses can share a common storage space.

In one example, the remote device of the system can be a handheld device such as a smartphone, laptop computer, or tablet that receives signals from each of the pressure sensors.

In one example, according to the teachings of the present disclosure, a fire suppression system includes a fire suppression apparatus configured to be installed in a target object targeted for fire protection. The fire suppression apparatus has a storage space containing a fire suppression agent under pressure. A remote device is configured to wirelessly communicate with the fire suppression apparatus. A first sensor is configured to periodically or continually measure the pressure within the storage space and to periodically or continually send a wireless signal to the remote device representing a measured pressure within the storage space. Another feature of the target object is configured to wirelessly communicate with the remote device, though the other feature is not targeted for fire protection. The other feature includes a second sensor configured to periodically or continually measure a characteristic of the other feature and to periodically send a wireless signal to the remote device representing a measured characteristic of the other feature.

In one example, the remote device can be a handheld device such as a smartphone, laptop computer, or tablet.

In one example, the target object can be within one or more building structures. The one or more building structures can include at least one of a house, an apartment, a condominium, a workshop, a utility room, an office space, a restaurant, or a manufacturing facility. One of the fire suppression apparatuses can be installed in each of the structures of the system, if more than one structure, and more than one of the apparatuses can be installed in any one of the structures to fire protect different aspects or features of the structure.

In one example, the fire suppression apparatus or apparatuses can be installed near at least one of an electrical outlet, a cooking hood, a kitchen appliance, a motorized machine, or HVAC equipment within the building structures.

In one example, the fire suppression system can include a plurality of the fire suppression apparatuses. At least a portion of the plurality of fire suppression apparatuses can be configured to be installed within walls and/or near ceilings of the one or more building structures.

In one example, the target object can be within one or more transportation units and the other feature can be a tire of the one or more transportation units.

In one example, the second sensor can be a pressure sensor and the measured characteristic can be a tire pressure of the tire.

In one example, the one or more transportation units can include at least one of a car, a truck, a bus, a recreational vehicle, a camper, a trailer, an airplane, a forklift, or an autonomous driving vehicle.

In one example, the fire suppression apparatus or apparatuses can be installed near at least one of an engine in an engine bay, an electrical outlet, a cooking hood, a kitchen appliance, or a motor of the one or more transportation units.

In one example, the measured characteristic of the other feature can be one or more of an AC system charge pressure, a tire pressure, a fire suppression sprinkler system water pressure, a vibration, or a temperature.

In one example, the first sensor, the second sensor, and the remote device communicate via a telematics system and a global positioning system (GPS).

### BRIEF DESCRIPTION OF THE DRAWINGS

The drawings provided herewith illustrate one or more examples or embodiments of the disclosure and therefore should not be considered as limiting the scope of the disclosure. There may be other examples and embodiments that may be equally effective to achieve the objectives and that may fall within the scope of the disclosure. Objects, features, and advantages of the present invention should become apparent upon reading the following description in conjunction with the drawing figures, in which:

FIG. 1 shows a simplified schematic of one example of an existing or prior art fire suppression system.

FIG. 2 shows a simplified schematic of a fire suppression system according to the teachings of the present disclosure.

FIG. 3 shows a close up view of a portion of a fire suppression apparatus in the form of a fire extinguisher unit of the fire suppression system of FIG. 2, and with the fire extinguisher unit connected to the system.

FIG. 4 shows the portion of the fire extinguisher unit of FIG. 3 but disconnected from the system.

FIG. 5 shows an alternate example of a fire suppression apparatus in the form of a fire extinguisher unit for a fire suppression system according to the teachings of the present disclosure.

FIG. 6 shows a simplified schematic of another example of a fire suppression system according to the teachings of the present disclosure

FIG. 7 shows a flow chart of one example of a fire suppression method using a disclosed fire suppression system according to the teachings of the present disclosure.

FIG. 8 shows another example of a fire suppression apparatus in the form of a fire extinguisher unit according to the teachings of the present disclosure.

FIG. 9 shows a simplified schematic expression of the fire extinguisher unit of FIG. 8.

FIG. 10 shows one example of a fire suppression system utilizing the fire suppression apparatus of FIGS. 8 and 9.

FIG. 11 shows one example of a faceplate for an electrical outlet that is protected by the fire suppression system and fire suppression apparatus, i.e., the extinguisher unit of FIG. 10.

FIG. 12 shows a simplified representation of another example of a fire suppression apparatus in the form of a fire extinguisher unit for a fire suppression system according to the teachings of the present disclosure.

FIG. 13 shows a simplified representation of another example of a fire suppression apparatus in the form of a fire extinguisher unit for a fire suppression system according to the teachings of the present disclosure.

FIG. 14 shows a simplified representation of another example of a fire suppression apparatus in the form of a fire extinguisher unit for a fire suppression system according to the teachings of the present disclosure.

FIG. 15 shows a simplified schematic representation of another example of a fire suppression system according to the teachings of the present disclosure.

FIG. 16 shows a simplified schematic representation of one example of a fire suppression system configuration according to the teachings of the present disclosure.

FIG. 17 shows a simplified schematic representation of one example of a fire suppression system configuration according to the teachings of the present disclosure.

FIG. 18 shows a simplified schematic representation of one example of a fire suppression system configuration according to the teachings of the present disclosure.

The use of the same reference numbers or characters throughout the description and drawings indicates similar or identical components, aspects, and features of the disclosure.

### DETAILED DESCRIPTION OF THE DISCLOSURE

It is broadly an object of the present disclosure to address one or more of the above mentioned problems and/or disadvantages with prior known fire suppression apparatuses, systems, and methods. The disclosed apparatus, system, and method may improve upon or minimize at least some of the above-mentioned problems and/or disadvantages.

According to a first aspect of the disclosure, a fire suppression system includes a pipe or tube, a valve arrangement with one or more valve assemblies, and a corresponding one or more fire extinguisher units coupled to the pipe or tube via the one or more valve assemblies. Each valve assembly includes a male/female connector. Each male/female connector has a first part attached to the respective fire extinguisher unit and a second part attached to the pipe or tube. Each valve assembly is configured to permit the respective fire extinguisher unit to be connected to the pipe or tube of the fire suppression system and to be disconnected from the pipe assembly. The fire suppression system may optionally remain operational whether a fire extinguisher unit is disconnected from the system. The fire extinguisher unit is manually operable as a typical fire extinguisher when disconnected from the fire suppression system.

According to another aspect of the disclosure, each fire extinguisher unit may be connected or disconnected with zero pressure or may be connected pressurized in order to meet with the required contained fire suppression agent. The valve assembly may be configured to contain or inhibit any fluid or pressure loss when connecting or disconnection a fire extinguisher unit to or from the fire suppression system.

According to another aspect of the disclosure, each valve assembly may be made of a suitable material, which can render the valve assembly corrosion resistant.

According to another aspect of the disclosure, when connected to the fire suppression system, if activated, the contained fire suppression agent may exit the tank of the fire extinguisher unit and will disperse from a fire suppression burst tube, nozzle, or other dispersion feature of the system and suppress a fire.

According to another aspect of the disclosure, one or more of the fire extinguisher units may be released or disconnected under pressure from the fire suppression system and may be used manually to suppress a fire. Each detached unit may be used as needed to manually and directly suppress a fire or a portion of the fire. Also, the unit may be used to suppress a fire in a non-suppressed environment at a location remote from the fire suppression system. The disconnected fire extinguisher unit may also be taken from one location to another to assist an activated fire suppression system. Once the fire extinguisher unit has been released from the fire suppression system, both the fire extinguisher unit and the fire suppression system may maintain the original starting pressure with minimal pressure or agent loss.

According to another aspect of the disclosure, the disclosed fire suppression apparatus, system, and method provide the advantage that a fire extinguisher unit can be made to quickly disconnect from the system when it is advantageous to do so. This may be accomplished, for example, by controlling the release of the male/female connector of the valve assembly and thereby controlling the release of agent from either the detached fire extinguisher unit or the pipe or tube of the fire suppression system. The fire extinguisher unit and/or fire suppression system may be ready to use within seconds or minutes after the unit is disconnected under pressure from the main fire suppression system. Such a controlled disconnection of the fire extinguisher unit from the fire suppression system ensures that, at any given moment, a backup system or in some cases a primary fire extinguisher would always be ready for use.

For example, if a fire suppression system was installed in a vehicle and the vehicle encounters an accident requiring a fire extinguisher, the trained occupant of the vehicle may easily disconnect a fire extinguisher unit and direct suppression agent to the fire. This may potentially save lives or assets. The same may apply for other circumstances and environments, such as mining equipment, aviation equipment, and the like.

According to another aspect of the disclosure, to initiate the disconnection of the male/female connector, one may move a release coupling and pull the fire extinguisher unit away from the suppression system. This may close one or more one-way valves.

According to another aspect of the disclosure, the first and second parts of the male/female connector of the valve assembly may be connected to each other with a set of one-way valves. The one-way valves may be poppet valves or the like, and may be of a pull to release type, a lift to release type, a turn to release type, a break to release type, a de-couple to release type, or the like. The presence of the one-way valves and the manual release operation help to ensure that the fire extinguisher unit is retained in position and secured as necessary while suppression agent can flow to the pipe or tube, especially when installed in a high vibration application. The presence of the one-way valves further helps to control the release of the fire extinguisher unit from the suppression system without a drop in pressure of loss of suppression agent from either the pipe or tube or the fire extinguisher unit.

According to another aspect of the disclosure, the valve assemblies may be made of a stainless-steel material, a carbon steel material, or the like. This may ensure that the valve arrangement is capable of maintaining good mechanical functionality while resisting corrosion and offering corrosion protection for the system.

According to another aspect of the disclosure, each detachable fire extinguisher unit may be adapted to move out of a first position connected to the fire suppression system only when a pin, handle, or coupling on one side of the fire extinguisher unit is removed or actuated. Thus, the movement can readily control the disconnection of the fire extinguisher unit.

According to another aspect of the disclosure, the fire extinguisher unit may be adapted to move out of the first position when a force applied by an actuator to one side of the male/female connector of a valve assembly exceeds a force threshold. This may advantageously facilitate remote actuation and controlled release by application of a physical force direct to the male/female connector. In one example, the actuator may be a remotely operated hammer or rod.

According to another aspect of the disclosure, O-ring seals may be provided between the first and second parts of the male/female connector joining a fire extinguisher unit to the fire suppression system to provide a seal therebetween.

According to another aspect of the disclosure, the fire suppression apparatuses or fire extinguisher units may be provided as part of a fire suppression system that includes telematics for monitoring the system.

According to another aspect of the disclosure, the fire suppression apparatuses may include a storage vessel made of a material that bursts or ruptures when exposed to fire. The suppression agent can be discharged through the rupture point to suppress the fire.

According to another aspect of the disclosure, the fire suppression apparatuses or fire extinguisher units may be provided as a part of a fire suppression system that includes GPS monitoring or tracking for use with systems having multiple locations and/or systems installed in transportation units or vehicles that move about.

According to another aspect of the disclosure, a fire suppression system can include fire suppression and telematics and can also include other features that are monitored via telematics though not targeted for fire suppression.

These and other objects, features, advantages, and aspects of the disclosed fire suppression apparatus, system, and method should become apparent to those having ordinary skill in the art upon reading this disclosure.

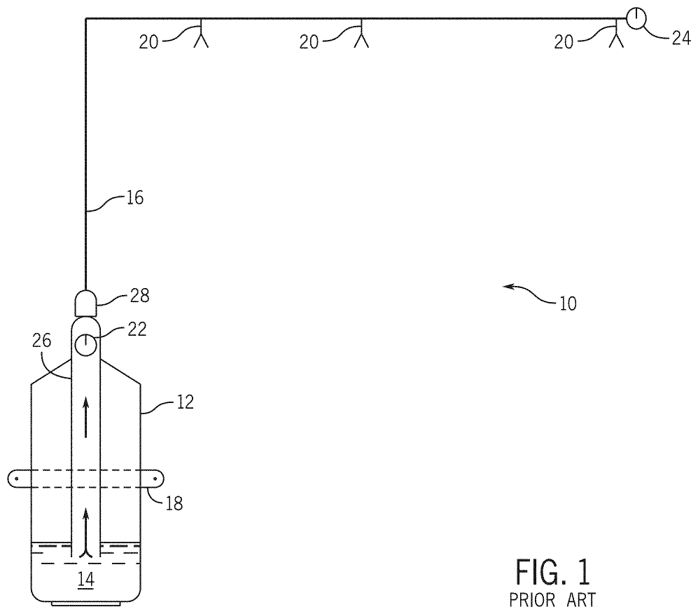

Turning now to the drawings, FIG. 1 shows a simplified schematic of a known fire suppression system 10. The system 10 includes a reservoir, container, or tank 12 holding a fire suppression agent 14. The tank 12 is connected to a tube or pipe 16 of the fire suppression system 10. The tank 12 is connected to a wall or surface by a clamp 18 and is not removable in emergencies or for secondary use. The pipe 16 may be a series of pipe segments joined together or may be a continuous tube. The pipe 16 includes one or more dispersion nozzles 20 to disperse the agent, when the system 10 is activated. The tank 12 may include a pressure gage 22 and the pipe 16 may also include a pressure gage 24. The gages 22, 24 can detect and display or indicate the pressure within the tank 12 and within the pipe 16 of the system 10, respectively. The tank 12 can include a feed tube 26 inside the tank to direct the suppression agent 14 from the tank, to exit the tank, and to the pipe 16.

FIG. 1 shows a standard fire suppression system 10 known in today's market. The tank 12 is typically hard connected to the pipe 16 and nozzles 20 of the fire suppression system 10 by the fixed connector or clamp 18. The system 10 acts as a single use fire suppression system. It should be noted that the tank is a storage reservoir and thus does not include a fire extinguisher handle, release lever, tamper seal, pull pin, and hose of a typical fire extinguisher. Instead, the tank 12 includes a single connector 28 that allows the pipe 16 to be connected directly to the tank. The system 10 maintains pressure within the tank 12 and the pipe 16. The system 10 operates by the nozzles 20 being actuated by smoke detection, fire detection, or the like and then releasing agent to suppress a fire. The fire suppressing agent may be water, foam, dry powder, CO₂, wet chemical, or the like, as is known in the art.

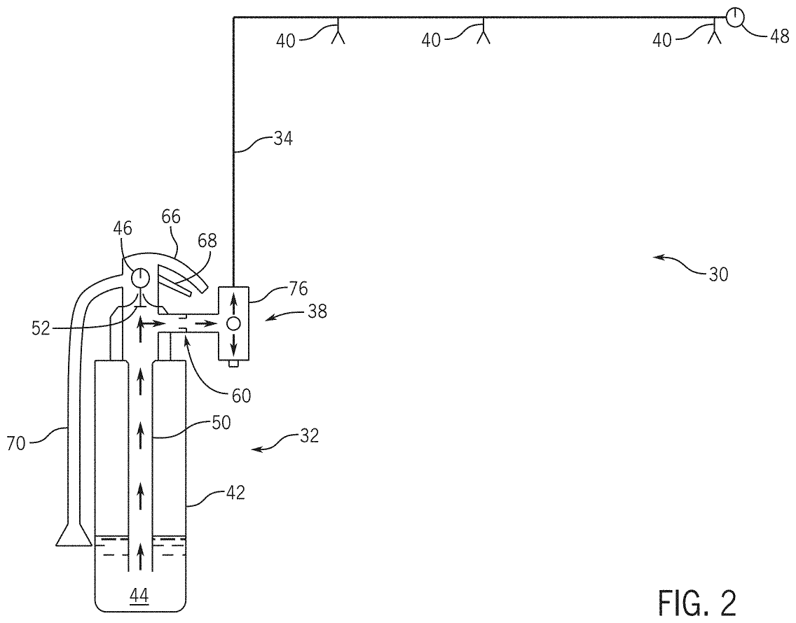

FIG. 2 shows a simplified schematic view of a fire suppression system 30 constructed according to the teachings of the present disclosure. The fire suppression system 30 includes at least one apparatus, i.e., a fire extinguisher unit 32 that is modified so as to be connectable to and detachable from the system. The system 30 may include two or more of the detachable fire extinguisher units, as is more clearly described below, though only one is specifically shown and described in this example. Alternatively, such a system may also include one or more non-removable storage reservoirs, such as an agent holding tank (like the tank 12 of FIG. 1). Though one fire extinguisher unit 32 is described below, the description may be considered to apply equally to any one or more additional such units of the system 30.

As shown in FIG. 2, the system 30 includes a tube or pipe, i.e., pipe 34, which may again include a series of pipe segments joined to one another at connectors or joints. The pipe may be a metal pipe, plastic tubing, or the like. The size, i.e., diameter of the pipe can vary according to the design needs of a given application. The system 30 also includes a valve arrangement with one or more valve assemblies 38. A valve assembly 38 can be provided to connect each of the fire extinguisher units 32 to the pipe 34. The fire extinguisher unit 32 in this example may be detachably connected to a wall or surface for reasons noted further below.

The pipe 34 has one or more dispersion features or elements. In one example, the dispersion features may again be in the form of a number of nozzles 40 provided along the pipe 34 to disperse the agent when the system 30 is activated. In another example, the pipe 34 may be in the form of plastic tubing with a pipe wall specifically designed to burst and disperse suppression agent at points subjected to flames or high temperatures caused by a fire. The fire extinguisher unit 32 includes a tank 42 that holds a pressurized fire suppression agent 44. The fire extinguisher unit 32 may include a pressure gage 46 and the pipe 34 may also include a pressure gage 48. The gages 46, 48 can detect and display or indicate the pressure within the tank 42 and within the pipe 34 of the system 30, respectively. The tank 42 can again include a feed tube 50 inside the tank to direct the suppression agent 44 to exit the tank. The fire extinguisher unit 32 can include pressure sensors as part of a telematics monitoring system, as discussed in more detail below. The sensors could be incorporated into the pressure gages 46, 48, for example to measure and monitor the pressure within the tank or the pipe and send such data to a user via telematics or the like.

In this example, the valve arrangement includes a first valve assembly, i.e., the valve assembly 38, coupled to the pipe assembly 34 as a part of the fire suppression system 30. The valve arrangement also includes a second valve assembly 52 provided as a part of the fire extinguisher unit 32. Each of the valve assemblies 38, 52 may be conventional in construction and may have mating flat-face, no spill couplings. Each valve assembly 38, 52 also may have a poppet style shut-off valve body. The valve assemblies 38, 52 and poppets may employ O-ring seals or metal-to-metal seating elements. Each valve assembly 38, 52 may also include a bias element or spring to assist closing the valves when the fire extinguisher unit 32 or the suppression system pipe 34 has low pressure in the system. The valve assemblies 38, 52 may be configured to withstand zero (0) to ten thousand (10,000) PSI covering low and high pressure systems. When the system 30 components are connected, the valve assemblies 38, 52 can be configured so that pressure and suppression agent 44 can be diverted from the tank 42 to the pipe 34 when the system is activated in an open condition.

The suppression system 30 can further include valves and connectors to connect additional elements together and to the system. Such elements may be optional and may include additional electronics, an emergency release, additional pressure gauges, one or more discharge ports, one or more charge ports, additional fire extinguisher units, additional storage tanks, and the like.

FIG. 2 shows the flow path of the fire suppression agent 44 from the tank 42 of the fire extinguisher unit 32 when the unit is connected to the suppression system 30 and when the system is activated upon detecting a fire. The second valve assembly 52 is closed and the first valve assembly 38 is open. The agent 44 thus may flow from the tank 42 through the valve assembly 38 and into the pipe assembly 34.

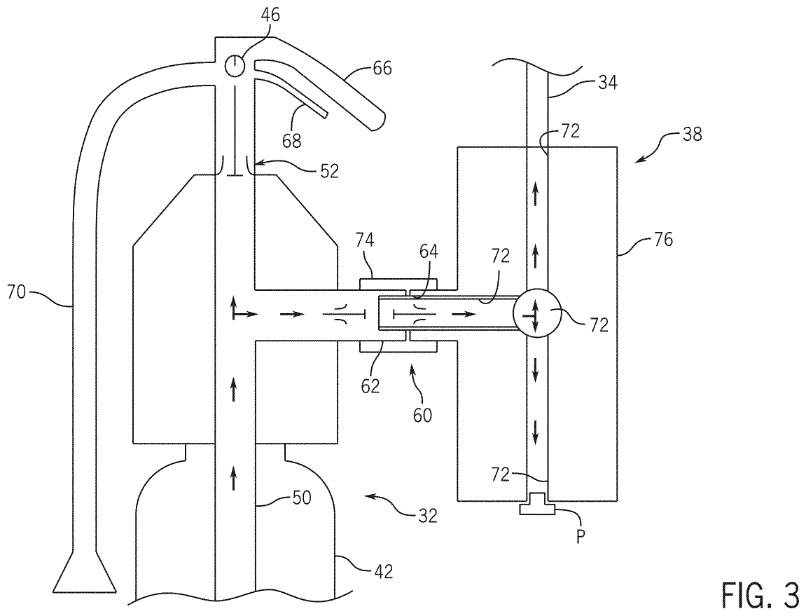

FIGS. 2 and 3 also show the differences between the known fire suppression system 10 of FIG. 1 and the fire suppression system 30 according to the teachings of the present disclosure. In this example, the apparatus, i.e., the fire extinguisher unit 32 and valve assembly 38, includes a feature allowing connection to and detachment from the fire suppression system 30. The feature includes a male/female connector 60 positioned between the fire extinguisher unit 32 and the pipe 34, and thus between the two valve assemblies 38, 52. The male/female connector 60 is a valve disconnection/connection device that joins the fire extinguisher unit 32 to the pipe 34 of the fire suppression system 30. The connector 60 has a first part 62 that is carried on the fire extinguisher unit 32 and a second part 64 that is carried on the pipe 34. When the first part 62 on the fire extinguisher unit 32 is connected to the second part 64 on the pipe assembly 34, the connector 60 is in an open flow condition permitting the tank 42 to fluidly communicate with the pipe 34 and thus transfer the agent 44 therebetween. Other differences lie in the fire extinguisher unit 32, which replaces the tank 12 of the known system in FIG. 1. The fire extinguisher unit 32 may include an extinguisher handle 66, a release lever 68, a tamper seal (not shown), a pull pin (not shown), and a hose 70.

The connector 60, when in the connected condition, diverts the agent 44 from the tank 42 of the fire extinguisher unit 32 to the suppression pipe 34 and thus to the dispersion features, such as the nozzles 40. This charges, i.e., pressurizes the fire suppression system 30, making it ready for activation. The readiness of the system 30 can be noted by checking the pressure via the one or more gauges 46, 48 that are installed within the system. The valve assembly 38 that is connected to the pipe 34 of the fire suppression system 30 has one or more ports 72. These ports 72 allow the system 30 to be energized with the agent 44, which can be a fluid, a powder, a gas, or a combination of such agents. The ports 72 of the valve assembly 38 also permit the system 30 to thus be charged and discharged and to distribute the agent through the system. The ports 72 further allow the valve assembly 38 and the fire extinguisher unit 32 to be interlinked and connected together with other elements of the system 30, such as one or more additional fire extinguisher units and valve assemblies, and/or with one or more additional fire suppression systems. The ports 72 also may connect to pressure and temperature switches, emergency activation switches, and/or emergency shut down (ESD) switches.

FIG. 3 shows a close up of a portion of the fire extinguisher unit 32 of FIG. 2. The connector 60 includes the first and second parts 62, 64, i.e., the male/female connector parts in this example. The first and second parts 62, 64 may be or include male and female parts that each carry a poppet valve that opens flow through the connector 60 when the fire extinguisher unit 32 is connected to the valve assembly 38 of the system 30. In the open position as shown, the agent 44 is allowed to flow from the tank 42 of the fire extinguisher unit 32 into the valve assembly 38, which directs and distributes the agent 44 into one or more suppression pipes 34 or other parts of the system 30.

As shown in FIG. 3, the connector 60 may include a coupling 74 that can lock the connector in the connected condition. At this stage, pressure and thus agent 44 can be transmitted from the fire extinguisher unit 32 to the pipe 34 of the fire suppression system 30. The agent 44, however, is not released into the atmosphere until a fire has been detected or the fire extinguisher unit 32 has been disconnected from the valve assembly 38 and used manually, as discussed below.

In the disclosed example, the fire suppression system 30 has a minimum of one (1) valve assembly 38 with one (1) connector 60 per system and at least one detachable fire extinguisher unit 32. The connector 60 also has at least two (2) one-way valves, one to close each part of the connector when disconnected. The disclosed connector and valve assembly are not limited herein to any specific design, configuration, valve type, connection type, or the like. The valves may be within the connector 60, within a body 76 of the valve assembly 38, or elsewhere, as long as they open when the unit 32 is connected to the system 30 and closed when the unit is detached. The connector 60 and one-way valves may be in a horizontal orientation adjacent the fire extinguisher unit 32 or may be vertically mounted above the fire extinguisher handle 66. The one-way valves open when the first and second parts 62, 64 of the connector 60 are connected and close and seal when disconnected. The body 76 may be termed a valve body, suppression block, or the like and may include a minimum of one port 72 that is separate from the connector flow path into the body. The port 72 can function as both an inlet port and an outlet port for flow of the agent 44 and for pressurization or charging of the system 30 with the agent. The valve body 76 may have additional ports 72 connected to additional parts or pipe sections of the system 30. Unused ports 72 may be closed off or plugged by suitable plugs P or other such devices. The valve body 76 may also be configured to include additional ports or connectors for connection of electrical components, emergency switches, pressure gauges, a bleed port, and the like.

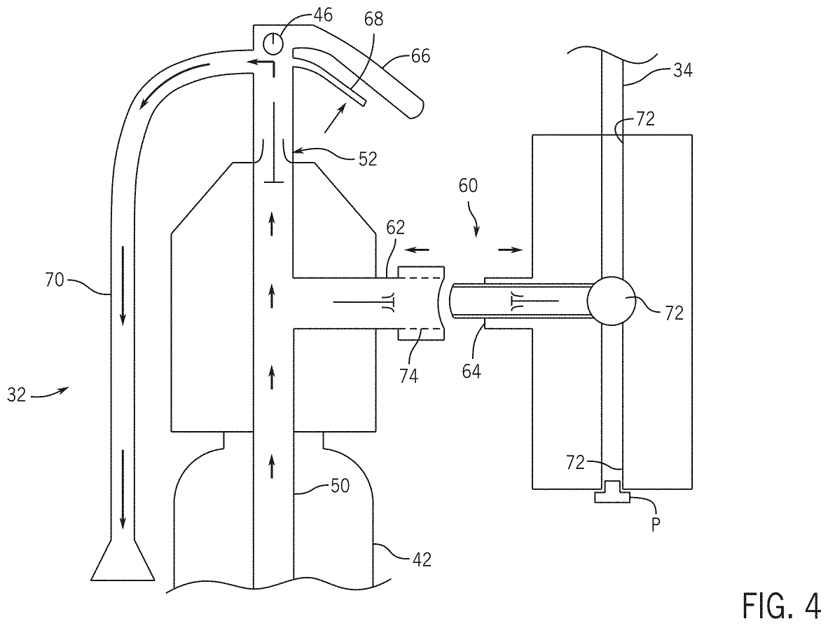

FIG. 4 shows the fire extinguisher unit 32 disconnected from the fire suppression system 30. When disconnected, the first and second parts 62, 64 of the connector 60 are disconnected from one another. In one example, the coupling 74 may be a threaded lock coupling that is rotated in one direction to release the connection and in the other direction to secure the connection of the connector 60. Disconnecting the connector 60 and releasing the first part 62 from the second part 64 closes the valve assembly 38, including the two one-way valves on the corresponding first and second parts. When closed and sealed, isolated system pressure is maintained in each of the parts 62, 64. Thus, the fire extinguisher unit 32 and the pipe 34 of the system are isolated from one another, blocking the pressure/flow of agent between the suppression system 30 and the detached fire extinguisher. This allows the fire extinguisher unit 32 to be removed and used manually.

The pipe 34 may be a smaller diameter plastic tube, such as a 3 mm to 5 mm inside diameter (ID) tube. With a smaller diameter tube size, the pipe 34 may not be functional as a suppression system 30, i.e., may not retain sufficient volume and pressure, to adequately suppress a fire with the fire extinguisher unit 32 detached. In other examples, the pipe 34 may be a larger diameter plastic tube, such as a 15 mm ID tube. With a larger diameter tube size, the pipe 34 may be functional as a suppression system 30, i.e., may retain sufficient volume and pressure, to adequately suppress a fire with the fire extinguisher unit detached.

In order to use the fire extinguisher unit 32 manually, a user should detach the unit and free up the release lever 68 and handle 66, such as by removing a lock pin or pull pin (not shown). Once ready, the user can detach the unit from the valve assembly 38 and manipulate the release lever 68 and handle 66 to open the valve assembly 52 on the fire extinguisher unit 32 to divert the agent 44 from the tank 42 to the hose 70. If the fire extinguisher unit 32 has not been activated and the agent not dispersed, the fire extinguisher unit may be reconnected to the valve assembly 38 of the fire suppression system 30. The fire extinguisher unit 32 can then be checked and made ready for use with the fire suppression system 30. If the fire extinguisher unit 32 has been used and the agent 44 discharged, the unit should be replaced or recharged and then can be reconnected to the system 30. If desired, the system 30 may be recharged through another port, remote from the fire extinguisher unit 32 or the valve assembly 38, once the unit is reconnected to the system. With the fire extinguisher unit 32 detached and ready for manual use, the remaining portions of the fire suppression system 30 may be deactivated.

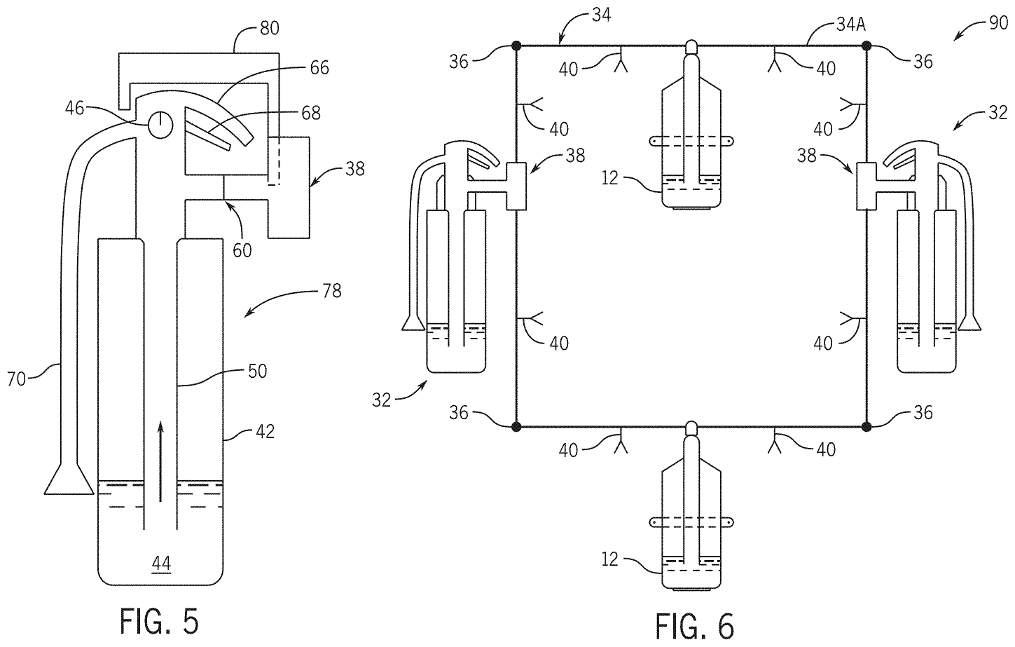

FIG. 5 shows an alternative example of a lock and release feature for the fire extinguisher unit 32, which may replace or supplement the above mentioned coupling 74. In this example, the fire extinguisher unit 32 may be fitted with a handle release mechanism 80. The handle release mechanism 80 may act as a locking device that, when attached to the fire extinguisher unit 32, secures the two one-way valves of the valve assembly 38 or connector 60 in the open position and secures the unit to the fire suppression system 30. When required or desired, the handle release mechanism 80 may be pulled, pushed, or otherwise actuated to release the fire extinguisher unit 32 from the suppression system 30. This action should also close the two one-way valves of the respective first and second parts 62, 64 of the connector 60 to isolate them from each other and allow the fire extinguisher unit to be detached and used manually. The handle release mechanism 80 may be useful in low vibration environments and used to compress the two one-way valves open until the mechanism is released.

FIG. 6 shows another simplified schematic of another example of a fire suppression system 90 constructed in accordance with the teachings of the present disclosure. The system 90 merely includes multiple elements described above for a more complex system. In this example, the pipe 34 includes a plurality of pipe segments 34a joint to one another at joints or connectors 36. These joints or connectors 36 are configured to permit flow of agent 44 along the various pipe segments 34a of the system 90. The joints or connectors 36 may also include additional ports for interconnecting further system elements, such as additional pipe segments 34, gauges, switches, ESD switches, a controller, a control panel, and the like.

In this example, the fire suppression system 90 includes two of the detachable fire extinguisher units 32. Each unit 32 can be separately detachable from the system 90 via a respective valve assembly 38 and used to suppress a fire. With one or both units 32 detached, the system 90 may still function to be capable of fire suppression. For example, the fire suppression system 90 also in this example includes two permanent or fixed agent storage tanks 12. These tanks 12 can be utilized to store additional suppression agent 44 and to aid in charging or pressurizing the system 90. The fire suppression system 90 also includes multiple dispersion features, such as nozzles 40, distributed along the pipe 34. These dispersion features may again vary and, for example, may be formed by the pipe 34 locally bursting when subjected to flames or high temperatures caused by a fire, as described above. Further, the system 90 in this example is shown as a closed system, with the pipe segments 34a joined to form a continuous agent flow circuit. Instead, the system may be configured similar to the systems 10 and 30, with a discontinuous flow path. Terminal ends of the pipe 34 may then be capped or plugged, as desired. A gauge (not shown) may be placed at each end of the open ended circuit to both close off the ends as well as to provide the pressure indication function.

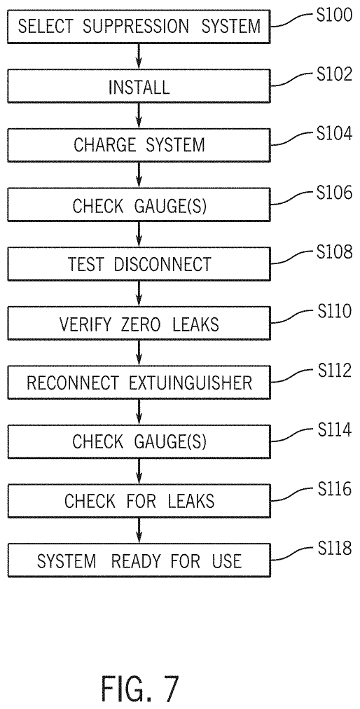

The foregoing describes a fire suppression apparatus and system. The apparatus and system may be readied for use, as represented in FIG. 7. The disclosed fire suppression apparatus and system may also be used to suppress a fire when activated, either with the system completely installed and assembled, or with the fire extinguisher unit 32 detached. FIG. 7 shows one example of a method flow chart for readying a fire suppression system. Other examples may include more steps or fewer steps than those steps depicted in FIG. 7, and may also include fire suppression steps, which are not represented in FIG. 7. In one example, a method may include designing and/or selecting a fire suppression system according to the needs of a particular environment (S100). The appropriate system is then installed in the environment (S102). Once installed, the system is charged with an appropriate fire suppression agent (S104). The charging may be done by connecting one or more of the fire extinguisher units 32 to the system or may be done via one of the pipe segments 34a or the pipe 34 of the system, remote from the one or more units 32. Once charged, numerous qualities or characteristics of the system can be checked. For example, the system charge pressure can be checked by noting the pressure at the gauge or gauges (S106). As another example, the one or more fire extinguisher units 32 can be disconnected to test the capability and function of the disconnect (S108). Also, the system can be checked for leaks (S110). In another example, as discussed below, the system may be continually or periodically checked and monitored via telematics remotely by a user using a handheld device or computer. Instead of or in addition to the gages, the fire extinguisher units can be fitted with sensors, such as tire pressure monitoring sensors (configured with telematic capability) to permit such periodic or continual pressure and system checks.

After the system checks are completed, the one or more fire extinguisher units 32 can be reconnected to the system (S112). The system pressure can again be checked, such as by noting the reading of the gauge or gauges (S114). The system can also again be checked for leaks (S116). The system may then be determined as ready for use (S118).

During use, the system may be activated manually to begin fire suppression. Alternatively, the system may be activated automatically. The dispersion features may be configured to automatically discharge agent upon detecting smoke, detecting fire or flames, or detecting a certain temperature threshold. Alternatively, the system may be connected to a controller or control board that is programmed to make the determination of activating the system. The components of that controller or control board may include one or more processor, sensors, and the like.

The disclosed fire suppression system 30 may also include other features and components. For example, the valve body of each valve assembly may be provided with multiple ports. Unused ports may be blocked off on an installed system, such as with the aforementioned plugs P. Each of the ports may be used for one or more functions, including delivery of the fire suppression agent, charging of the system, discharging of the system, connection to a pressure gauge, connection of additional pipe segments, emergency shut down, connection to a control panel, and/or the like. The control panel can be added and utilized to control and monitor various system parameters and functions. The control panel can be configured and operated to control charging and discharging, monitor pressure, shut down and activate the system, conduct an emergency shut down, detect leaks, detect improper valve operation and fire extinguisher unit connection, and the like.

The fire extinguisher unit or units 32 may be disconnected from the fire suppression system 30 in a variety of ways. In one example, the unit may be lifted away from the valve assembly 38 when the unit is released from a mounted carrier (not shown). In another example, the unit may include an electronic release coupled to a controller, control unit, control panel, or the like. The electronic release may allow the one-way valves of the connector 60 to be closed with an emergency release or ESD button, closing both valves and sealing the system before the fire extinguisher unit is removed by hand. This type of system may also be connected to machinery and may shut down mechanical or electronic systems when the fire suppression system is activated, or when the fire extinguisher unit is released.

In another example, the connector 60 may include only a single one-way valve on the first part 62. When the fire extinguisher unit is detached or disconnected, the one-way valve will isolate the unit to maintain the agent and pressure in the tank 42 so that the unit may be used manually to suppress fire. However, in this example, the pipe 34 of the suppression unit would then leak agent and/or lose pressure and would not be available for use to suppress fire. Such a system might be used for lower cost applications or small tight spaces where a single use fire suppression activation might be expected. Such a system might also be used for smaller ID pipe where the system might not be capable of maintaining sufficient volume or fluid pressure to suppress fire anyway, once the fire extinguisher unit is detached.

In another example, the fire extinguisher unit may include a safety, i.e., pull or push pin that must be removed before the unit can be released. The unit may include a push-to-release or pull-to-release mechanism or feature. A handle or lever, which in emergencies releases the unit from the suppression system when pushed or pulled may allow the safety pin to be removed before the fires extinguisher unit is released. In another example, the valve assembly may be vertically mounted with the valve arrangement. The valve assembly may permit a twisting or rotating movement, either left or right, allowing the fire extinguisher unit to drop and release from the fire suppression system. In another example, the valve assembly may permit the fire extinguisher unit to be turned or rotated to unscrew the unit from the valve assembly. In another example, the fire extinguisher unit may require a combination of push, pull, and release of a safety pin or a break bar to remove the unit. In another example, the fire extinguisher unit may again include an electronic release as noted above but may also have a built in or programmed memory and sensors linked to ESD functions that are built into the fire suppression system or the environment in which the system in installed.

As noted above, the fire suppression systems and fire suppression apparatuses or fire extinguisher units can vary in configuration and construction. In one example, the fire suppression apparatus may include a first storage vessel with an outer wall extending between a first end and a second end of the first storage vessel. The storage vessel may define a storage space within the outer wall between the first and second ends. A stored amount of a fire suppression agent may be contained under pressure within the storage space. At least a portion of the outer wall may be formed of a material that is configured to rupture when exposed to extreme heat or flame or fire and to discharge the fire suppression agent from the storage space at a location of rupture. The storage vessel may be comprised of one part or two or more parts, such as a tube or multiple tubes connected together.

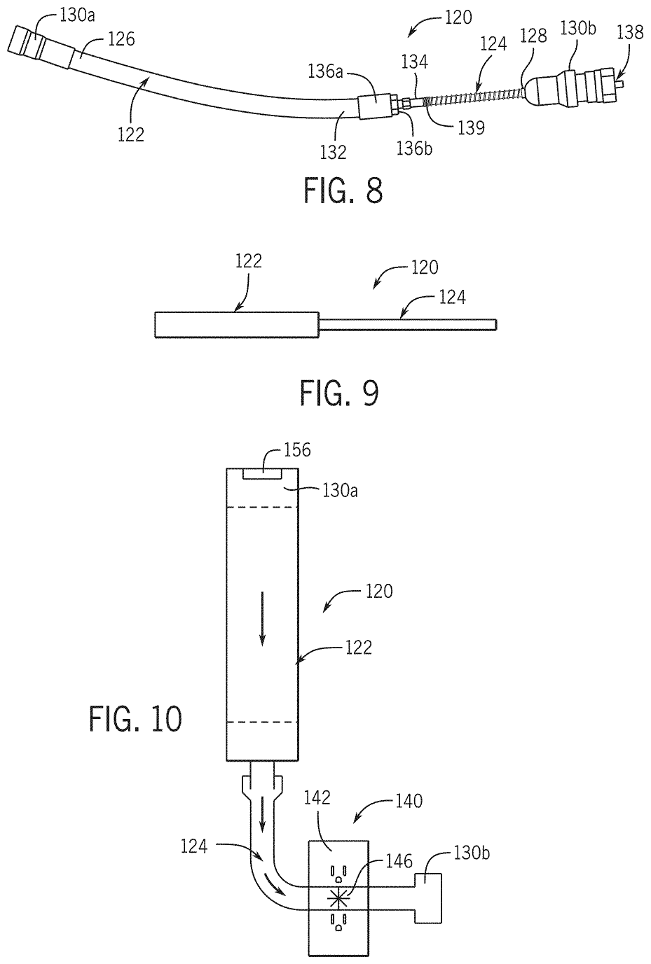

For example, FIGS. 8 and 9 show further examples of a fire suppression apparatus in a different form of a fire extinguisher unit 120 in accordance with the teachings of the present disclosure. FIG. 8 shows an example of a fire extinguisher unit 120 with multiple parts and FIG. 9 shows a simplified schematic illustration of the unit 120. The fire extinguisher units 120 could replace one or more of the earlier described, more conventional fire extinguisher units in a fire suppression system. However, as should become evident upon reading the below disclosure, the units 120 would not be removable and would be one-time use units instead of rechargeable or detachable, re-attachable, and re-usable more conventional fire extinguisher units.

In this example, the fire extinguisher unit 120 is configured as a stand-alone fire suppression “system” or unit. However, the fire extinguisher unit may be linked to a network of two or more of the units or to a larger system. In this example, the fire extinguisher unit 120 includes a first tube portion 122 of a first, larger diameter and a second, smaller diameter tube portion 124 connected to the first tube portion. In one example, the first tube portion 122 may be a larger, 18 mm diameter tube and the second tube portion 124 may be a smaller, 6 mm diameter tube. In this example, the tube portion 122 may be used for storing a desired volume of fire suppressing agent under pressure. The tube portion 124 may be provided to fit into tight spaces and may also store fire suppressing agent. The shape and size (tube cross-section, length, diameter, etc.) of the tube portions 122, 124 can vary according to the design constraints and performance characteristics or fire suppression needs of a particular intended use.

In one example, either one or both the tube portions 122, 124 may be formed of a flammable or non-flammable material. Also, either one or both tube portions 122, 124 may also be formed of a material that bursts when exposed to heat or flame, as discussed above. Thus, one or both of the tube portions 122, 124 may act as a nozzle, once the tube bursts, for dispensing the fire suppressing agent. The material may be a plastic material, a steel or steel alloy based material, an aluminum alloy or aluminum based material, or the like. Alternatively, as noted above, either or both of the tube portions 122, 124 may be fitted with nozzles to disperse the fire suppression agent when heat or flame is detected. Such detection may occur through one or more sensors (not shown) provided on a portion of the fire extinguisher unit 120, as noted below among different examples and embodiments.

The free end 126, 128 of each tube portion 122, 124, respectively, may include a cap 130a, 130b attached thereto to seal the interiors of the tubes. The proximal joined ends 132, 134 of each tube portion 122, 124, respectively, may also include a cap 136a, 136b configured to be joined or connected to one another to connect the tube portions. The caps 136a, 136b may be configured to allow fluid communication between the tube portions 122, 124 via a passage or valve defined through the connected caps. In one example, one of the end caps 130 may include a valve 138, such as a one-way valve or fill valve. The fire extinguisher unit 120 may be filled or charged with a fire suppressing agent via the valve 138. The above-noted sensors may be provided on one or more of the end caps 130a, 130b, on one or more of the connected caps 136a, 136b, or on another portion of the fire extinguisher unit 120. The smaller tube portion 124 in this example has a sheath in the form of a coil spring 139. The sheath can be provided to aid in protecting the second tube portion 124 as it is bent and manipulated during installation and to inhibit the tube portion from becoming kinked or pinched when installed. The sheath should, however, allow for the outer wall to burst or rupture when exposed to a fire and to discharge the fire suppression agent through the sheath. Alternatively, the sheath may also be configured to burst or rupture, as needed.

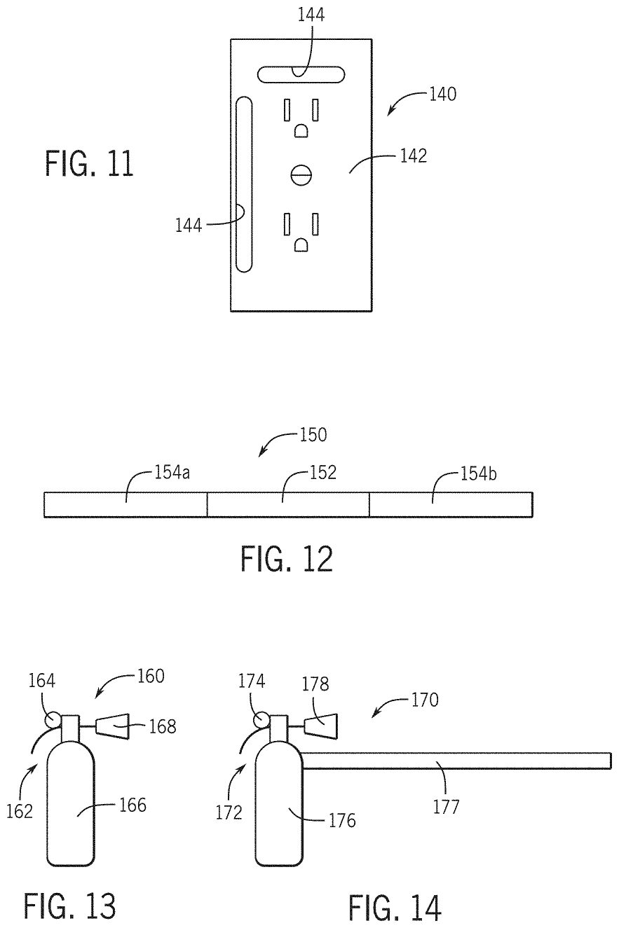

FIGS. 10 and 11 depict the fire extinguisher unit 120 installed in a wall to suppress fire near or at an electrical outlet 140. The tube portion 122 having the larger size and/or diameter may be disposed in a wall between two joists and the tube portion 124 may be routed as needed to reach and be disposed near or adjacent the junction box of the wall outlet 140. Further, a face plate 142 of the outlet can be especially configured to include one or more slots, holes, or other type cut-outs, i.e., openings 144. These openings 144 may allow fire suppressing agent released from behind the wall from the tube portion 124 (and/or 122) to reach a fire within the interior of the room and near the electrical outlet 140 or to be released from a nozzle (not shown) or a burst tube portion that is exposed in the room through an opening 144 in the face plate 140.

The fire extinguisher unit 120 may be used by itself as a stand-alone unit, if desired. The unit 120 may simply be installed in a location as desired and can function to suppress a fire at that location, should the unit be exposed to extreme heat or flame. The tube 124 may either burst, such as at 146 to disperse the suppression agent, or may have a nozzle to accomplish that, as noted above. Extreme heat may be defined, in one example, as a temperature that equals or exceeds a threshold temperature, which would cause the tube material to burst and disperse fire suppression agent or which would cause a nozzle of the unit to open and disperse fire suppression agent. In this example, the fire extinguisher unit 120 need not be connected or linked to any other unit or system. The fire extinguisher unit 120 may thus be highly adaptable and capable of being installed in virtually any desired location or on or near any desired object to protect against fire damage, as needed.

The stand-alone fire extinguisher unit 120 may be used in many different environments and on or adjacent a wide variety of objects. Such environments may include, but are not limited to, in home kitchens, commercial kitchens, workshops, manufacturing facilities, vehicles, trailers, and the like. Each of these environments can also be narrowed or divided into sub-environs or specific objects within them for targeted fire protection and suppression. For example, the fire extinguisher unit 120 may be used under or near a stove, cooking appliance, or a cooking hood in a kitchen of a home, an office, a restaurant, a recreational vehicle, a boat, a camper, or the like. The fire extinguisher unit may be used adjacent a fuse box, an electrical junction, an electrical outlet, a switch board, or the like in a home, a commercial building, a manufacturing facility, or the like. The fire extinguisher unit 120 may also be used within an engine compartment of a car, a truck, an airplane, a boat, or on another type of moving object like a drone, a forklift, an autonomous driving vehicle or mover, or the like. The disclosed fire extinguisher unit 120 is a highly adaptable, versatile apparatus that can be used to protect to a wide variety of different objects, spaces, and the like.

In another example, two or more of the fire extinguisher units 120 may be used in the same environment, though not specifically shown herein. The multiple units 120 can then either be entirely separate from one another and used to protect multiple different aspects or objects of an environment. Alternatively, the multiple units 120 can be connected to one another via a joining tube or tubes containing fire suppression agent. The suppressing agent and the joined fire extinguisher units can be configured so that, if a fire occurs adjacent one of the multiple units, that unit can disperse the suppression agent from the joined system. In another example, discussed further below, the multiple units 120, whether or not physically connected to one another, may be linked to one another as a part of a wireless monitored system.

FIG. 12 shows another example of a fire extinguisher unit 150 in accordance with the teachings of the present disclosure. In this example, the fire extinguisher unit 150 has a hybrid charge and includes multiple tube portions joined together, which may be in the same or a similar manner as that described above for the fire extinguisher unit 120. Each of the tube portions may have the same tube diameter or may have different diameters. Also, each of the tube portions may have the same length or may have different lengths. In this example, the fire extinguisher unit 150 has 152 central tube portion, and two end tube portions 154a, 154b connected to the opposite ends of the central tube portion 152. At least the central tube portion 152 may be configured to burst when exposed to extreme heat or flame, but all three of the tube portions may also be configured to burst to create a discharge nozzle/point for the suppression agent. The central tube portion 152 may contain a dry chemical fire suppression agent such as a type A, B, or C, type agent, which may be under pressure within the central tube portion. The two end tube portions 154a, 154b may contain an inert gas under pressure. In this example, when the central tube portion is exposed to extreme heat or flame, the tube material may burst. The inert gas in the end tube portions 154a, 154b can be provided at a pressure and volume to ensure that all of the A, B, C suppression agent is dispersed to suppress a fire.

Similar to FIG. 9, FIG. 12 shows a simplified schematic illustration of the fire extinguisher unit 150. The fire extinguisher units 150 could also replace one or more of the earlier described, more conventional fire extinguisher units in a fire suppression system. However, as should become evident upon reading the below disclosure, like the units 120, the units 150 would also not be removable and would be one-time use units instead of rechargeable or detachable, re-attachable, and re-usable more conventional fire extinguisher units. Further, each of the fire suppression apparatuses or extinguisher units of FIGS. 8, 9, 10, and 12, as well as the additional units described below, may be fitted with a pressure gage to manually or visually check pressure, telematics (see further below) to periodically or continually monitor pressure, or a combination of both.

As noted above, the various fire suppression apparatuses disclosed and described herein may be connected to one or more other apparatus within a fire suppression system. As also noted above, the fire suppression apparatuses may be linked to one another in a monitored fire suppression system. Further, the fire suppression apparatus can be linked with other monitored objects as well within such a monitored system.

A fire suppression system can include a fire suppression apparatus, or more than one, configured to be installed in a target object, or target objects, targeted for fire protection. The fire suppression apparatus may have a storage space containing a fire suppression agent under pressure. A remote device may be configured to wirelessly communicate with the fire suppression apparatus. A first sensor, or more than one, may be configured to periodically or continually measure the pressure within the storage space, or storage spaces, and to periodically or continually send a wireless signal, or signals, to the remote device representing a measured pressure within the storage space, or storage spaces. Another feature, or features, of the target object, or target objects, may be configured to wirelessly communicate with the remote device. The other feature or features may not be targeted for fire protection. The other feature or features may include a second sensor, or more than one, configured to periodically or continually measure a characteristic, or characteristics, of the other feature or features and to periodically send a wireless signal or signals to the remote device representing a measured characteristic, or characteristics, of the other feature or features.

First, returning to FIGS. 8 and 10, a fire suppression apparatus, such as the fire extinguisher unit 120, may be fitted with electronic components that provide wireless monitoring capability through a telematics type arrangement. In this example, the fire extinguisher unit 120 may include a pressure sensor 156 on a portion of the unit, such as on the end cap 130a of the tube portion 122. As described further below, the pressure sensor 156 can monitor the pressure within the fire extinguisher unit 120 and the data can be wirelessly communicated to another part of the fire suppression system. The sensor 156 can help by continuous or periodic monitoring of the internal pressure of the fire extinguisher unit 120. The sensor can help determine whether the fire extinguisher unit 120 is faulty, such as having a leak and slowly losing pressure, and that data or information can be relayed to a user. The sensor 156 can also help determine whether there may be a fire or other catastrophic event at the location of the unit when a sudden pressure drop is detected, and that data or information can be wirelessly relayed to a user.

The electronic components may also include a global positioning system (GPS) feature or aspect. Thus, the precise location of the unit 120 may be detected and determined. As noted below, the fire extinguisher unit 120 may be installed in a fixed, static structure or may be installed in a dynamic or mobile object, such as a vehicle. Thus, the precise location of the unit 120 may be of the utmost importance when a fire or other catastrophic event occurs. The electronic components may also be configured to identify the specific fire extinguisher unit 120 within a larger system and that data or information may also be relayed to a user.

FIG. 13 shows another wireless monitored fire suppression system 160, or at least a part of such a system. In this example, the suppression system 160 may include one or more conventional fire extinguisher units 162, similar to those described above, for example, but not connected to any other fire suppression feature. The fire extinguisher unit 162 in this example also include electronic components connected to or carried on the head of the unit. The electronic components may again include a pressure sensor 164 that is configured and arranged to detect the pressure of the fire suppression agent within a tank 166 of the unit. In this example, the fire extinguisher unit 162 is a stand-alone unit that is monitored as a part of the fire suppression system 160. The unit 162 can be monitored for leaks or for discharge events where the tank is emptied, such as when used to put out a fire. In this example, the fire extinguisher unit 162 may have a conventional discharge nozzle 168 and may be used in a conventional manner to put out a fire. The sensor and the GPS/telematics may function the same as discussed above for the unit 120 and may make the otherwise conventional fire extinguisher unit 162 unique.

FIG. 14 shows another example of a wireless monitored fire suppression system 170, or at least a part of such a system. In this example, the suppression system 170 may include one or more fire extinguisher units 172, like those described above, for example. The fire extinguisher unit 172 in this example also include electronic components connected to or carried on the head of the unit. The electronic components may again include a pressure sensor 174 that is configured and arranged to detect the pressure of the fire suppression agent within a tank 716 of the unit. In this example, the fire extinguisher unit 172 is connected to a fire suppression tube 177, which may be a part of a system 170 and as described above with respect to FIGS. 1-7 or which may be a fire extinguisher unit, such as the units 120 or 150. In this example, the fire extinguisher unit 172 maybe detached from the tube 177 and used separately in a conventional manner to discharge the suppression agent contents from the tank 176 via a nozzle 178. Alternatively, when connected to the tube 177, the tank 176 may be used to charge or assist in charging other parts of the fire suppression system 170 with suppression agent from the tank via the tube. The fire extinguisher unit 172, as well as the tube 177 if desired, can again be monitored for leaks or for discharge events where the tank 176 or the tube 177 is emptied, such as when used to put out a fire. The sensor and the GPS/telematics may function the same as discussed above for the units 120 and 162. Also, the pressure sensor on the fire extinguisher units 160 and 170, as well as any other unit disclosed herein, may be installed internal or external to the tank or storage vessel.

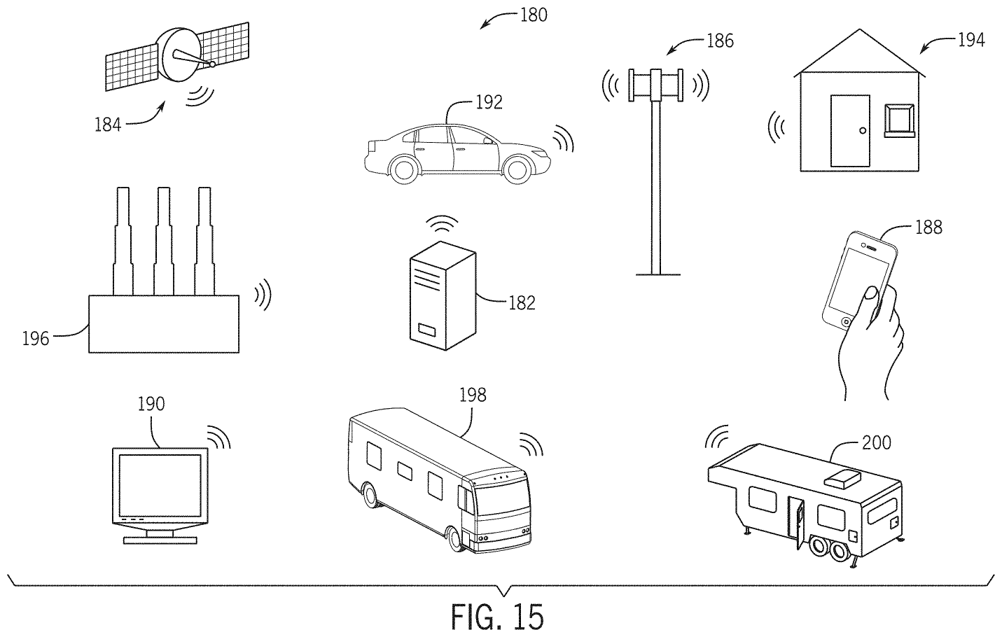

FIG. 15 shows a simplified representation of a telematics/GPS system 180 configured for use in conjunction with the teachings of the present disclosure. A telematics system may be used to track and monitor various systems and various aspects of such systems. The telematics system 180 generally may include one or more secure servers 182 that provide the software and hardware for storing, operating, controlling, and/or maintaining the disclosed fire suppression systems. The telematics system 180 disclosed herein also may include wireless communication via a satellite 184 to track the location of various aspects or objects of the system through GPS or other location and tracking technology. The telematics system 180 may also include wireless communication via a cellular network 186 or another signal transmission network. The telematics system 180 may also include wireless communication with electronic devices connected to the secure server 182. Such devices may include handheld smart phones 188 and computers 190, such as tablets, mobile or laptop computers, desktop computers, and the like.

The telematics system 180 may also include fire suppression apparatuses, such as those described herein, installed in a variety of environments. Such environments may include, but are certainly not limited to, a car 192, a commercial vehicle such as a tractor trailer, a bus, or the like (not shown), a home 194, a restaurant or other commercial or retail space (not shown), an office building or complex (not shown), a workshop (not show), a manufacturing facility 196, a recreational vehicle (RV) 198, a camper 200, or the like. Within these types of environments, the fire suppression apparatuses may be deployed in kitchens near cooking appliances, cooker hoods, and the like, may be deployed near electrical outlets, electrical control panels, and the like, may be deployed in equipment rooms near tools, HVAC systems, and the like, may be deployed on working equipment such as forklifts, lifts, robots, and the like, may be deployed in engine compartments, and may be deployed near other types of equipment and objects that may pose a fire hazard or risk of fire.

The telematics system 180 may also include pressure sensors for sensing pressure of other features and equipment within any of these environs. For example, tire pressure sensors may be provided on vehicles that also include one or more fire suppression apparatuses on board the vehicle. Some tire pressure monitoring systems are known that provide wireless communication capability. These types of sensors, in one example, may also be utilized as the fire suppression apparatus pressure sensors as well. However, other types of sensors may certainly be used as well. The system 180 can monitor tire pressure and can notify a user whether a tire on a car, 192, RV 198, trailer or camper 200, or the like has a slow tire leak or has experienced a catastrophic tire failure via a change in monitored pressure. Further, such sensors may also be utilized on refrigerant lines of air conditioning equipment system of a vehicle or a structure. Also, such sensors may be utilized on sprinkler systems within a vehicle or a structure as well. These types of sensors may be used to monitor refrigerant pressure, water pressure, or the like as a part of the telematics system 180 and as a feature of the disclosed fire suppression systems to detect slow leaks or complete discharge events for such equipment.

Also, according to the teachings of the present disclosure, a power cut-off switch (not shown) may be included as a part of the electronic components or a s a separate component as a part of the disclosed fire suppression systems and telematics systems. The power cut-off switch may be triggered to cut power to an electrical outlet, to a particular room, to a whole structure or object, or to multiple structures or objects, if a fire is detected. The power cut off switch may be wirelessly connected to a part of the system or may be hard wired to a part of the system, such as a fire suppression apparatus, as well as to the power supply line or lines within the environment. The power cut off switch can also be deployed anywhere that power can be cut, as needed, such as being mounted directly to an electrical control panel, a fuse box, a breaker panel, or the like. Further, the disclosed systems may include temperature sensing capability, vibration sensing capability, and the like, also tied into the telematics/GPS. These can be used for a wide variety of monitoring purposes, such as monitoring the temperature of a refrigerator or a home, the operation stability of a pump, or the like.

Below, in Table 1, just a few examples are provided of telematics and fire suppression systems that may be configured for various environments according to the teachings of the present disclosure. Many other examples may be devised and even the below examples in Table 1 may be changed within the spirit and scope of the present disclosure.

| Home | Vehicles | Camper/RV | Trailer | Office | Workshop |
|---|---|---|---|---|---|
| | AC | AC | | | |
| Cooker hood | | Cooker hood | | Cooker hood | Cooker hood |
| Electrical Outlet | | Electrical Outlets | | Electrical Outlet | Electrical Outlet |
| Extinguisher | Extinguisher | Extinguisher | Extinguisher | Extinguisher | Extinguisher |
| HVAC | | | | HVAC | HVAC |
| | | | | | Plant Equipment |
| Power cut off switch | | | | Power cut off switch | Power cut off switch |
| | | Refrigerator | | | Release system |
| Release system | Release System | Release System | Release System | Release system | |
| | | | | Server rooms | |
| Sprinkler system | | | | Sprinkler system | Sprinkler system |
| Switch board | Replay/Fuse box | Switch board | | Switch board | Switch board |
| | Tire monitor | Tire monitor | Tire monitor | | |

The scope of the fire suppression system and telematics system can vary widely depending on the design needs and constraints of a given application. The systems may be as simple as having one fire extinguisher unit 120 installed in a target object and a handheld device retained by a user. The user can check the handheld device to monitor the state of the lone unit. The handheld device may also provide a signal, whether it be audible, visual, vibration, or the like, to the user when there is a change in state of the fire extinguisher unit 120, such as when the sensed pressure of the unit changes or drops below a threshold pressure level, or when the unit has discharged the fire suppression agent. Such a system may also include a server holding the service software or program, a cellular network, and/or a satellite/GPS function. Other examples can merely build on this basic system by including one or additional fire suppression units, and/or one or more additional target objects, and/or one or more additional structures and/or vehicles, and/or other measured characteristics of aspects of the system. All such system arrangements and configurations are intended to be included in the disclosed systems.

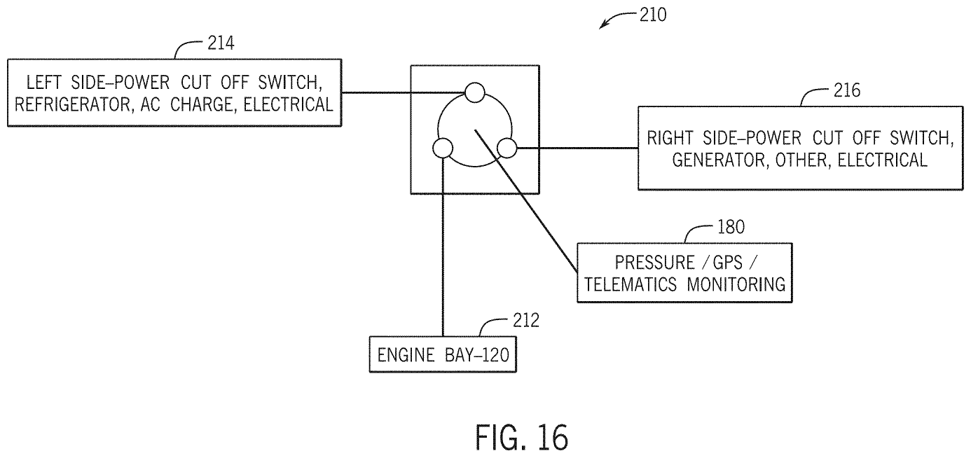

FIGS. 16-18 show simplified depictions of specific fire suppression and telematic systems within the spirit and scope of the present disclosure. As shown in FIG. 16, one example of a fire suppression system 210 may be installed in an RV 198. The system 210 shows that the RV may be equipped with a fire extinguisher unit 120 in the engine compartment 212 of the RV. The system 210 may also include on the left side 214 of the RV an electrical power cut off switch, a refrigerator sensor, an AC charge sensor, a fire extinguisher unit 120 for electrical outlets, and the like. The system 210 may also include on the right side 216 of the RV an electrical power cut off switch, a generator sensor, an AC charge sensor, a fire extinguisher unit 120, and the like.

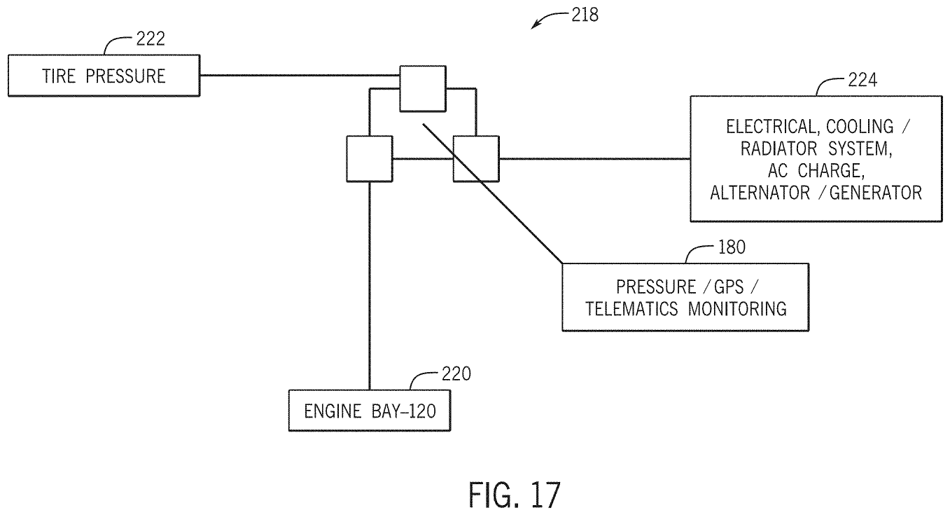

FIG. 17 shows one example of a fire suppression system 218 that may be installed in a car 192. The system 218 shows that the car be also equipped with a fire extinguisher unit 120 in the engine compartment 220 of the RV. The system 218 may also include tire pressure sensing 222 on the wheels of the car. The system 218 may also include sensing 224 of the cooling/radiator system (temperature and/or pressure), AC charge system, sensing of the alternator/generator, a fire extinguisher unit 120 adjacent the electrical fuse box, and the like.

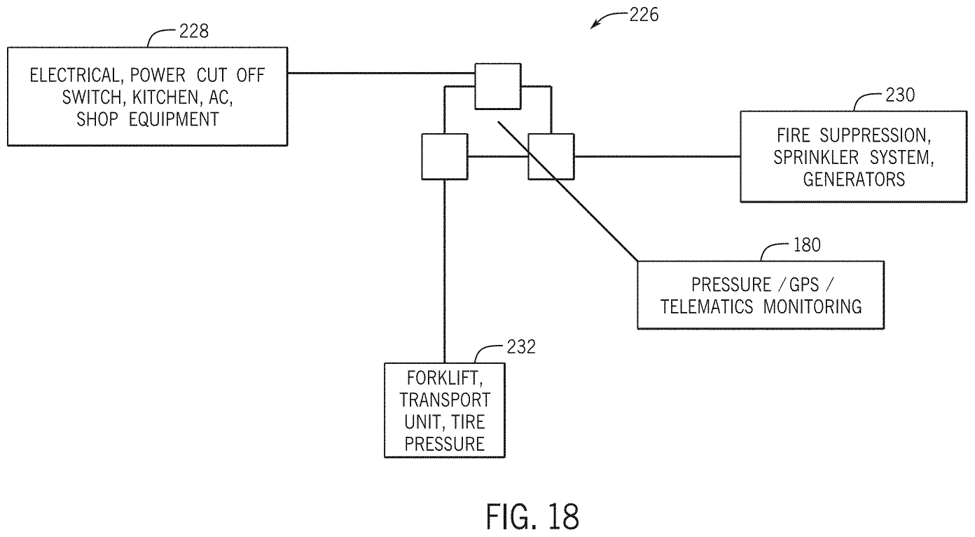

FIG. 18 shows one example of a fire suppression system 226 that may be installed in a workshop or manufacturing facility 196, i.e., shop. The system 226 shows that the shop can be also equipped 228 with multiple fire extinguisher units 120 for various electrical equipment within the shop. The system 226 may also be equipped 228 with power cut off capability, fire suppression in kitchens, AC system charge monitoring, and plant equipment monitoring and fire suppression. The system 226 may also include fire suppression 230 for the overall facility. This may include a connected system as described with respect to FIGS. 1-7 above and installed throughout the shop. The system 226 may also include fire suppression, tire pressure monitoring, and other monitoring 232 for working vehicles within the shop, such as forklifts, transport units, and the like that can move about the shop and even beyond the shop.

For transportation units, such as those noted above and herein, some may not be fitted with fire suppression or any type of monitoring. However, a fire extinguisher unit as disclosed herein, such as a unit 120, could be cost effectively added. The fire extinguisher unit 120 could also be fitted with a sensor and monitored via telematics, if desired, without having any other system features or components added.

As noted previously, the disclosed fire suppression systems and telematics/GPS monitoring systems may be used for a range of applications in a wide variety of environments. Some examples include: vehicle engine bays; vehicle crew cabs; server rooms; industrial machines; aviation environments; on board airplanes and helicopters; mining environments and equipment; other transportation environments and equipment; motorsport vehicles, garages, and the like; kitchens; buildings; petrochemical facilities; fuel trucks; paper plants; airports and depots; conveyor systems; document rooms; boat, ships, cruise liners, and the like; hospitals; hotels; private homes; gas stations; military vehicles, equipment, and environments; offshore installations; wind turbines; and the like.

The disclosed fire suppression systems can be used and charged quickly and easily with minimal downtime. The disclosed fire suppression systems and telematics/GPS monitoring systems are easy to assemble, install, and maintain. Use of flexible plastic tubing as the pipe allows for fitting the system into tight spaces and within and around complex shaped areas, machines, and the like. The disclosed fire suppression systems are also easy to activate and use, whether automatically or manually, as an installed, connected unit, or manually with one or more fire extinguisher units detached. The fire suppressing agent can be liquid, gas, powder, or a mixture of any such agents, depending on the location and hazards within the area. The chosen agent may be suitable for a given environment so as not to require significant clean up, if activated, and so as not to damage the environment and articles and equipment in that environment. The fire suppressing agent may be water, foam, dry powder, CO₂, wet chemical, or the like, as is known in the art.

The disclosed dispersion elements may vary as well. Conventional nozzles are described above as one option for the fire suppression system. However, other types of dispersion elements or features may be utilized instead. In one example, the dispersion elements may be localized bursts of the pipe or tubing. Such a burst may be caused by localized heat from a fire elevating the temperature at a point or location along the pipe in combination with the relatively high internal pressure within the system. If the temperature reaches a certain threshold, the pipe at that point or location may be configured to burst, allowing the pressurized agent to escape and suppress fire within reach of the burst region of the pipe. In one example, the entire wall of the pipe may be capable of bursting, if subjected to localized heat, thus permitting a burst at any position along the pipe. In other examples, burst points, such as thinner walled or weakened points, may be provided along the pipe, each configured to burst or capable of bursting.

Although certain fire suppression apparatuses, systems, and methods have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A fire suppression apparatus comprising:
a first storage vessel having an outer wall extending between a first end and a second end of the first storage vessel and defining a storage space within the outer wall between the first and second ends; and
a stored amount of a fire suppression agent contained under pressure within the storage space,
wherein at least a portion of the outer wall is formed of a material that is configured to rupture when exposed to extreme heat or flame or fire and to discharge the fire suppression agent from the storage space at a location of rupture.

2. The fire suppression apparatus of claim 1, wherein the material of the portion of the outer wall is flammable or non-flammable.

3. The fire suppression apparatus of claim 1, further comprising:
a pressure sensor configured to measure a pressure within the storage space and to send a wireless signal to a remote device representing a measured pressure within the storage space.

4. The fire suppression apparatus of claim 3, wherein the remote device is a handheld device comprising a smartphone, laptop computer, or tablet.

5. The fire suppression apparatus of claim 1, wherein the first storage vessel includes a first tube portion and a second tube portion with a proximal end of the first tube portion connected to a proximal end of the second tube portion, the first and second tube portions combining to define the storage space.

6. The fire suppression apparatus of claim 5, wherein the first tube portion has a larger diameter in cross section than the second tube portion and wherein at least the second tube portion is flexible allowing the outer wall of the second tube portion to be bent or deformed.

7. A fire suppression system comprising:
a plurality of the fire suppression apparatuses of claim 1 configured to be installed within a target object.

8. The fire suppression system of claim 7, wherein each of the plurality of the fire suppression apparatuses includes corresponding storage space and a pressure sensor configured to measure a pressure within the corresponding storage space and to send a wireless signal to a common remote device representing a measured pressure within the corresponding storage space.

9. The fire suppression system of claim 8, wherein the remote device is a handheld device comprising a smartphone, laptop computer, or tablet.

10. A fire suppression system comprising:
a fire suppression apparatus configured to be installed in a target object targeted for fire protection, the fire suppression apparatus having a storage space containing a fire suppression agent under pressure;
a remote device configured to wirelessly communicate with the fire suppression apparatus;
a first sensor configured to periodically or continually measure the pressure within the storage space and to periodically or continually send a wireless signal to the remote device representing a measured pressure within the storage space; and
another feature of the target object configured to wirelessly communicate with the remote device, the other feature not targeted for fire protection,
wherein the other feature includes a second sensor configured to periodically or continually measure a characteristic of the other feature and to periodically send a wireless signal to the remote device representing a measured characteristic of the other feature.

11. The fire suppression system of claim 10, wherein the remote device is a handheld device comprising a smartphone, laptop computer, or tablet.

12. The fire suppression system of claim 10, wherein the target object is within one or more building structures comprising at least one of a house, an apartment, a condominium, a workshop, a utility room, an office space, a restaurant, or a manufacturing facility.

13. The fire suppression system of claim 12, wherein the fire suppression apparatus is installed near at least one of an electrical outlet, a cooking hood, a kitchen appliance, a motorized machine, or HVAC equipment.

14. The fire suppression system of claim 12, further comprising a plurality of the fire suppression apparatuses, wherein at least a portion of the plurality of fire suppression apparatuses are configured to be installed within walls or near ceilings of the one or more building structures.

15. The fire suppression system of claim 10, wherein the target object is within one or more transportation units and wherein the other feature is a tire of the one or more transportation units.

16. The fire suppression system of claim 15, wherein the second sensor is a pressure sensor and the measured characteristic is a tire pressure of the tire.

17. The fire suppression system of claim 15, wherein the one or more transportation units comprise at least one of a car, a truck, a bus, a recreational vehicle, a camper, a trailer, an airplane, a forklift, or an autonomous driving vehicle.

18. The fire suppression system of claim 15, wherein the fire suppression apparatus is installed near at least one of an engine in an engine bay, an electrical outlet, a cooking hood, a kitchen appliance, or a motor of the one or more transportation units.

19. The fire suppression system of claim 10, wherein the measured characteristic of the other feature is one or more of an AC system charge pressure, a tire pressure, a fire suppression sprinkler system water pressure, a vibration, or a temperature.

20. The fire suppression system of claim 10, wherein the first sensor, the second sensor, and the remote device communicate via telematics and a global positioning system (GPS).
